(19) United States
(12) Patent Application Publication
(10) Pub. No.: US 2010/0053805 A1
(43) Pub. Date: Mar. 4, 2010

(54) HARD DISK DRIVE AND METHOD OF MANUFACTURE

(75) Inventors: Dongho Oh, Seoul (KR); Ha Yong Kim, Seoul (KR); Ja Choon Koo, Seoul (KR); Kyoung Ho Kim, Seoul (KR); Byoung Choul Choi, Gyeongbuk (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/547,600

(22) Filed: Aug. 26, 2009

(30) Foreign Application Priority Data
Aug. 26, 2008 (KR) 10-2008-0083310

(51) Int. Cl. G11B 17/08; G11B 5/127

(52) U.S. Cl. 360/98.07; 29/603.03; 29/737; G9B/17.041

(57) ABSTRACT

A method of manufacturing a hard disk drive includes measuring an imbalance value including an imbalance position with respect to a rotation center of a rotation shaft of the hub, with respect to each of a plurality of disks installed on a hub of a spindle motor to rotate the disks, allowing different imbalance positions of the disks to approach each other in a circumferential direction by applying an impact to the hard disk drive, and correcting the imbalance value by applying an impact to the hard disk drive in a direction opposite to the imbalance positions of the disks approaching each other with respect to the rotation shaft of the hub, to move the imbalance positions of the disks approaching each other in a radial direction of the disks with respect to the rotation center of the rotation shaft of the hub.

### PRIORITY STATEMENT

This application claims the benefit of Korean Patent Application No. 10-2008-0083310 filed on Aug. 26, 2008, the subject matter of which is hereby incorporated by reference.

### BACKGROUND

1. Field of the Invention

The inventive concept relates to a method of manufacturing a hard disk drive (HDD), a device configured to the manufacture of a HDD, and the resulting HDD. More particularly, the inventive concept relates to a method of manufacturing a HDD that corrects the dynamic imbalance value for the HDD, a device configured for this purpose and the resulting HDD.

2. Description of the Related Art

In general, HDDs are devices that record data on a magnetic disk and/or reproduce data stored on a disk by using a read/write head. The HDDs are widely used as auxiliary memory devices in computer systems because of their relatively fast data access speeds and their large data storage capacity. Recent design trends towards greater data density per unit device size have increased the number of data tracks per inch (TPI) and bits per inch (BPI) provided by contemporary HDDs.

In HDDs comprising one or more rotating disks, a mechanical imbalance may be generated due to certain eccentricities in the mass distribution of the rotating body. The imbalance may cause vibration and noise during operation of the HDD. In particular, disk eccentricities in a disk stack, for example, may damage a ball bearing or a fluid bearing of an associated spindle motor, thereby deteriorating the overall reliability of the HDD.

Although there are many possible specific causes for the generation of dynamic imbalance in the disk stack assembly, such dynamic imbalances are primarily generated because the respective rotation centers of constituent elements, such as the spindle motor, disk, and/or spacer in a disk stack assembly, do not have correlated centers of gravity with respect to a center of rotation.

As the data storage capacity of HDDs increases, dynamic imbalances once regarded as harmless have now become an issue of serious consideration in the design and operation of high performance HDDs. To improve accuracy of read/write functions and further reduce vibration and noise, such imbalances must be controlled within well defined limits. Additionally, HDD manufacturers prefer simple correction methods and related devices, since HDD are mass produced at relatively low cost points.

One example of conventional techniques used to correct imbalances are certain methods that involve measuring a basic imbalance in a single plane during manufacture followed by the addition of a compensating counterweight. The counterweight is generally attached with an adhesive to a clamp holding a disk, or by coupling the counterweight within an installation hole of the clamp that does not have a clamp screw inserted therein. Another conventional method involves the generation of intentional geometric biases in a disk during the manufacture process to counteract identified imbalances, thereby minimizing the imbalance.

However, such previously proposed methods actually generate a number of new problems as track density increases. In particular, methods generating geometric biases affect not only 1× but also nX for repeatable runout (RRO). Although dynamic imbalance may be corrected using various servo control methods, such methods impose an added computational burden to the HDD controller. Finally, problems are emerging with the RRO characteristics of HDD providing very dense data track layouts (i.e., elevated TPI counts).

### SUMMARY

The inventive concept provides methods of manufacture for hard disk drives (HDDs) that accurately correct disk assembly imbalances. This is particularly true for HDDs incorporating a plurality of disks. Embodiments of the inventive concept also provide resulting HDDs and devices adapted for use within the foregoing methods.

According to an aspect of the inventive concept, there is provided a method of manufacturing a hard disk drive, comprising; for each one of a plurality of disks installed on a hub of a spindle motor rotating the plurality of disks, measuring an imbalance value including an imbalance position with respect to a rotation center of a rotation shaft of the hub, allowing different imbalance positions for disks in the plurality of disks to approach each other in a circumferential direction by applying an impact to the hard disk drive, and correcting at least one imbalance value by applying an impact to the hard disk drive in a direction opposite to a corresponding imbalance position for a disk in the plurality of disks, wherein different imbalance values are made to approach each other with respect to the rotation shaft of the hub, and different imbalance positions of disks in the plurality of disks are made to approach each other in a radial direction with respect to the rotation center of the rotation shaft of the hub.

According to another aspect of the inventive concept, there is provided a hard disk drive comprising; a hub of a spindle motor, and a plurality of disks installed on the hub, wherein a slip mark is formed on a surface of each one of the plurality of disks within an angular range of 180° in a circumferential direction with respect to the center of each of the disks.

According to another aspect of the inventive concept, there is provided a device for manufacturing a hard disk drive comprising; a movable frame supporting the hard disk drive having a plurality of disks, and an impact application unit connected to the movable frame and configured to apply an impact to the hard disk drive during rotation of the disks.

### BRIEF DESCRIPTION OF THE DRAWINGS

Exemplary embodiments of the inventive concept will be more clearly understood from the following detailed description taken in conjunction with the accompanying drawings in which:

FIG. 1 is a perspective view of an HDD according to an embodiment of the inventive concept;

FIG. 2 is a perspective view illustrating device configured for the manufacture of an HDD according to an embodiment of the inventive concept;

FIG. 3 is a partial perspective view further illustrating an impact application unit for the HDD of FIG. 2;

FIG. 4 is a plan view for a main frame of the HDD of FIG. 2;

FIG. 5 conceptually illustrates the correlation of a control unit of the HDD of FIG. 2;

FIG. 6 is a flowchart summarizing a method of manufacturing an HDD according to an embodiment of the inventive concept;

FIG. 7 schematically illustrates imbalance values for a plurality of disks according to an embodiment of the inventive concept;

FIG. 8 schematically illustrates different imbalance positions for the disks of FIG. 7, as configured to approach each other as an impact is applied to the HDD in a direction within an angle of 180° made by the imbalance positions;

FIG. 9 schematically illustrates the different imbalance positions of the disks of FIG. 7, as configured to approach each other as an impact is applied to the HDD when an angle made by the imbalance positions is not greater than a predetermined angle range; and

FIG. 10 schematically illustrates a corrected imbalance made by applying an impact to the HDD in a direction opposite to the imbalance positions of the disks, as made to approach each other as the result of approaches taken in FIG. 8 or 9.

### DESCRIPTION OF EMBODIMENTS

The attached drawings illustrate various embodiments of the inventive concept and may be referred to in order to gain a sufficient understanding of the inventive concept and its merits. Throughout the written description and drawings, like reference numerals are used to indicate like or similar elements.

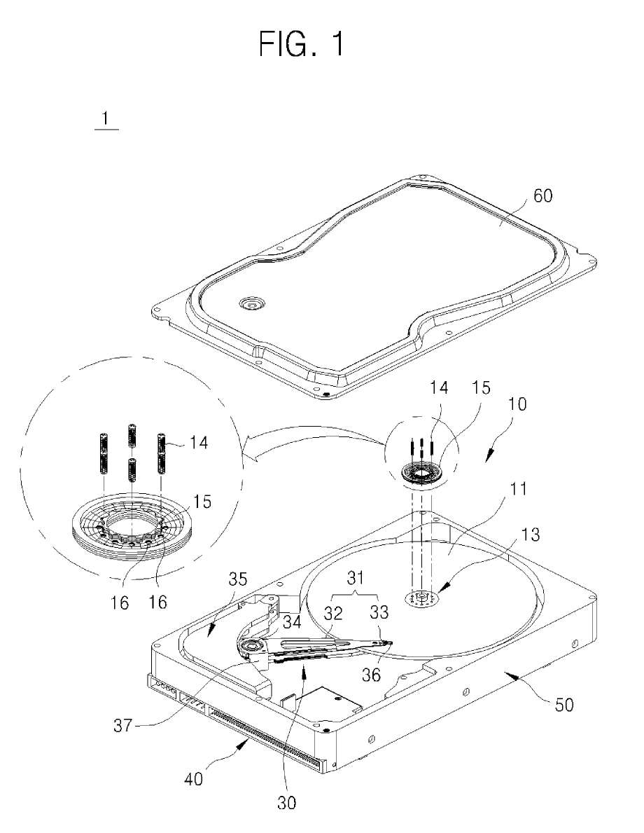

FIG. (FIG.) 1 is a perspective view of an HDD 1 according to an embodiment of the inventive concept. Referring to FIG. 1, the HDD 1 comprises a disk stack assembly 10 having a plurality of disks 11 for recording and storing data, a head stack assembly (HSA) 30 on which a head 36 is installed. The head 36 rotates around a pivot shaft 34 and moves across the disks 11 to read data from the disks 11. A printed circuit board assembly (PCBA) 40 includes most of the principal components that control various elements. A base 50 supports assembly of the constituent elements, and a cover 60 covers the base 50. When a recording or reproduction operation is initiated using the above structure, the head 36 is moved to a predetermined position above the rotating disks 11 to perform the recording or reproduction operation.

The HSA 30 includes an actuator arm 31 moving the head 36 to access data on the disks 11, a pivot shaft holder 37 rotatably supporting the pivot shaft 34 and to which the actuator arm 31 is coupled and supported, and a bobbin (not shown) extending from the pivot shaft holder 37 in a direction opposite to the actuator arm 31 and having a voice coil motor coil (VCM coil) wound around the bobbin to be located between a pair of magnets of VCM 35.

The actuator arm 31 includes a swing arm 32 rotating around the pivot shaft 37 by the VCM 35 and a suspension 33 supported by the swing arm 32 and having the head 36 attached at a leading end portion of the suspension 33.

The VCM 35 is a sort of a drive motor to pivot the actuator arm 31 to move the head 36 to a desired position on the disks 11 according to the Fleming's left hand rule, that is, a force is generated when current flows in a conductive body existing in a magnetic field. When current is applied to the VCM coil located between the magnets, a force is applied to the bobbin so that the bobbin may pivot. Accordingly, the actuator arm 31 extending from the pivot shaft holder 34 in the opposite direction to the bobbin pivots so that the head 36 supported at the end portion of the actuator arm 31 may search a track to access information and signal process accessed information while moving across the disks 11 in a radial direction.

The disk stack assembly 10 for rotating the disks 11 includes a plurality of disks 11 recording and storing data, a spindle motor 13 having a spindle motor hub (not shown) supporting the disks 11 and rotating the disks 11, and a clamp 15 elastically pressing the disks 11 to fix the disks 11 on the spindle motor hub when a plurality of clamp screws 14 are inserted in a plurality of installation holes 16 formed in the clamp 15 so that the clamp screws 14 are coupled to the spindle motor hub. As the clamp screws 14 are inserted in the installation holes 16 of the clamp 15 and screw-coupled to the spindle motor hub, the clamp screws 14 press the inner edge portion of the clamp 15 and thus the outer edge portion of the clamp 15 elastically presses the disks 11. Thus, the disks 11 are fixed on the spindle motor hub.

As the spindle motor hub rotates, the disks 11 fixed to the spindle motor hub rotate with the spindle motor hub. That is, as a starter core (not shown) and the magnets installed on the spindle motor hub interact to generate an electromagnetic force. The electromagnetic force rotates the spindle motor hub. Accordingly, the disks 11 fixed to the spindle motor hub are rotated at the same time.

In the HDD 1 according to the present embodiment, a slip mark is formed on a surface of each of the disks 11 within a range of 180° in a circumferential direction with respect to the center of each of the disks 11. The formation of the slip mark allows different imbalance positions for the disks 11 to approach each other with respect to the rotation center of a rotation shaft of the spindle motor hub when an impact is applied to the HDD 1. This impact essentially corrects any inherent imbalance in the HDD 1, as it is applied in an opposite direction to identified imbalance positions of the disks 11. The impact is made to achieve said “approach” during temporarily fixed state of manufacture during which the disks 11 are not finally or completely fixed by the clamp 15.

That is, during the HDD manufacture process, the slip mark is formed on the surfaces of the disks 11 within a semi-circular range of 180° with respect to the center of each of the disks 11 to allow different imbalance positions respectively associated with the disks 11 and with respect to the rotation center of the rotation shaft of the spindle motor hub to approach each other when an appropriate mechanical impact is applied to the HDD 1. According to this type of imbalance correction method, imbalance in the HDD 1 may be accurately corrected using a relatively simple manufacturing step within the overall manufacturing process for the HDD 1 which includes a plurality of disks 11.

A device configured to the manufacture of an HDD according to an embodiment of the inventive concept and implementing the above described imbalance correction method will now be described.

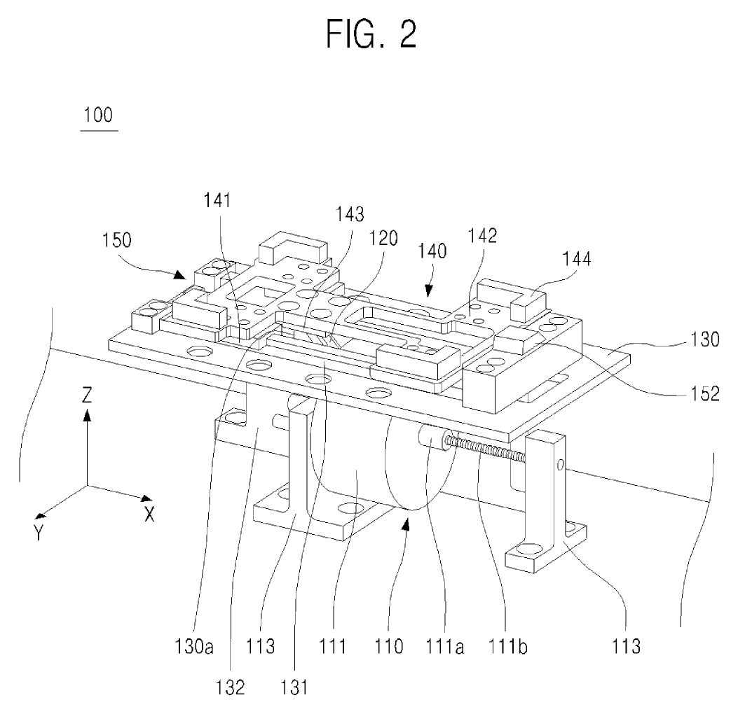

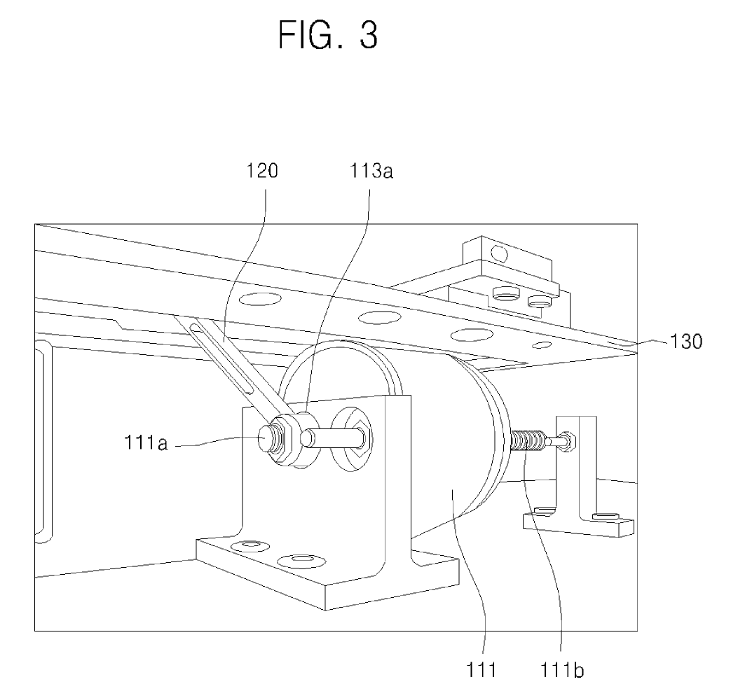

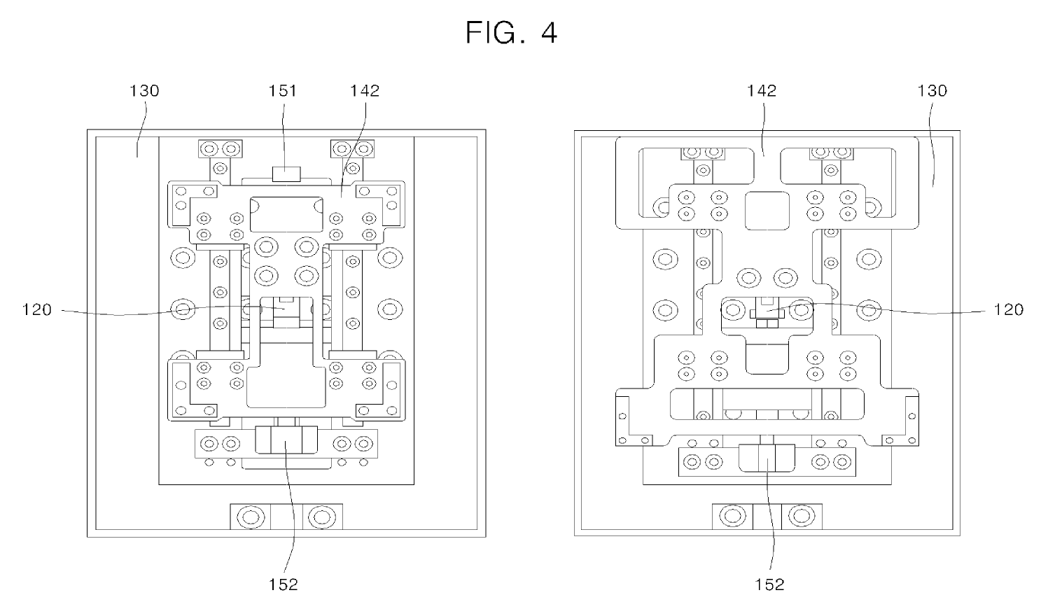

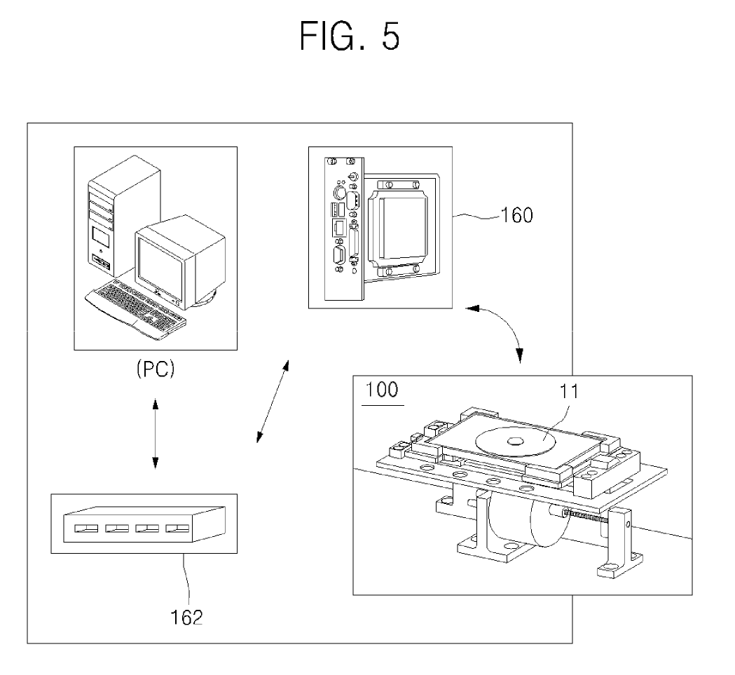

FIG. 2 is a perspective view of this device according to an embodiment of the present inventive concept. FIG. 3 is a partial perspective view further illustrating a principal component (an impact application unit) of this device. FIG. 4 is a plan view of a main frame of the HDD manufacturing device of FIG. 2. FIG. 5 illustrates the correlation of a control unit of the HDD manufacturing device of FIG. 2.

Referring to FIGS. 2-5, a device 100 for manufacturing an HDD according to an embodiment of the inventive concept includes an impact application unit 110, a fixed frame 130, a movable frame 140, an acceleration sensing unit 150, and a control unit 160.

The impact application unit 110 generates an impact to allow different imbalance positions of the disks 11 to approach each other and correct imbalance values of the disks 11 in which the imbalance positions are made to approach each other. The impact application unit 110 includes a solenoid 111 having a movable iron core 111a, a spring 111b returning the movable iron core 111a to the original position after an impact is applied, and columns 113 supporting the solenoid 111 from the ground.

As it is well known, when energy is supplied to a coil (not shown) provided in the solenoid 111, the movable iron core 111a is moved by magnetic attraction generated in the coil. The amount of movement is proportional to the energy supplied to the solenoid 111. That is, when the energy supplied to the solenoid 111 is large, the amount of movement of the movable iron core 111a increases accordingly. The spring 111b is coupled to an end portion of the movable iron core 111a to return the movable iron core 111a to the original position after movable iron core 111a applies an impact.

The columns 113 support the solenoid 111 to be separated from the ground. An end portion of the solenoid 111 and an end portion of the spring 111b are fixed to the columns 113. Also, a through hole 113a is formed in the column 113 at which the end portion of the solenoid 111 is fixed so that the movable iron core 111a may penetrate the through hole 113a to freely move therein. However, the columns 113 may be manufactured in a single body not in the two separate bodies as in the present embodiment.

Although the solenoid 111 is used as a member for applying an impact in the present embodiment, the present inventive concept is not limited thereto and a piezo actuator may be used instead. However, when the solenoid 111 is used, a relatively cheap device may be implemented.

The impact application unit 110 further includes a connection member 120 for transferring the impact applied by the solenoid 111 to the movable frame 140. While an end portion of the connection member 120 is coupled to an end portion of the movable iron core 111a, the other end portion thereof is coupled to a connection member coupling plate 143 provided on the movable frame 140. When an impact is applied by the impact application unit 110, the connection member 120 coupled to the end portion of the movable iron core 111a is moved. Accordingly, the movable frame 140 coupled to the end portion of the connection member 120 is relatively moved with respect to a guide rail 131 provided on an upper surface of the fixed frame 130.

The fixed frame 130 is provided between the impact application unit 110 and the movable frame 140, is supported by a column 132 above the ground, and includes the guide rail 131 provided on the upper surface of the fixed frame 130. The fixed frame 130 separates the impact application unit 110 and the movable frame 140 from each other. As the impact application unit 110 and the movable frame 140 are completely separated from each other by the fixed frame 130, particles generated due to the driving of the impact application unit 110 may not be moved toward the movable frame 140. Thus, since the device 100 for manufacturing an HDD according to the present embodiment is capable of preventing the particles that may be absorbed into the disks 11, reliability of the HDD 1 may be improved.

The guide rail 131 guides the movement of the movable frame 140 and is provided in a pair at both sides of the upper surface of the fixed frame 130. The movable frame 140 is relatively moved with respect to the guide rail 131 by a guide rail coupling portion 141 coupled to the guide rail 131 to be capable of relatively moving with respect to the guide rail 131, when an impact is applied by the impact application unit 110.

The movable frame 140 accommodates the HDD 1 and corrects the imbalance values of the disks 11 according to the application of an impact by the impact application unit 110. The movable frame 140 includes the guide rail coupling portion 141, a main frame 142 on which the HDD 1 is accommodated, a connection member coupling plate 143 coupled to a lower surface of the main frame 142, and a bracket 144 provided at each end portion of the main frame 142.

The guide rail coupling portion 141 is provided at a lower end portion of the main frame 142 and coupled to the guide rail 131 to be capable of relatively moving with respect to the guide rail 131. Accordingly, the main frame 142 is relatively moved along the guide rail 131 when an impact is applied by the impact application unit 110.

The main frame 142 on which the HDD 1 having the disks 11 is accommodated is detachably coupled to the connection member coupling plate 143. In the device 100 for manufacturing an HDD according to the present embodiment, the main frame 142 may be separated from the connection member coupling plate 143 and then a new main frame may be coupled to the connection member coupling plate 143. Accordingly, the device 100 for manufacturing an HDD according to the present embodiment may be used to correct imbalance values of not only 2.5 inches HDDs but also 3.5 inches HDDs.

In FIG. 4, the main frame 142 corresponding to 2.5 inches HDDs and the main frame 142 corresponding to 3.5 inches HDDs are illustrated in the left and right sides, respectively. The main frame 142 corresponding to 2.5 inches HDDs and the main frame 142 corresponding to 3.5 inches HDDs are substantially the same except for the size thereof.

The connection member coupling plate 143 is provided at a lower end portion of the main frame 142 and is coupled to the end portion of the connection member 120. As described above, the connection member coupling plate 143 is detachable from the main frame 142.

The bracket 144 is fixed at each corner of the main frame 142 to prevent movement of the HDD 1 accommodated on the main frame 142. When the impact application unit 110 applies an impact, the main frame 142 is relatively moved to the guide rail 131. However, since the HDD 1 is fixed to the bracket 144, only the disks 11 constituting the HDD 1 slips so that the imbalance values of the disks 11 may be corrected.

The device 100 for manufacturing an HDD according to an embodiment of the inventive concept further includes the acceleration sensing unit 150. The acceleration sensing unit 150 includes a first sensing unit 151 and a second sending unit 152 which sense accelerations of the disks 11 constituting the HDD 1 and detect the imbalance values including imbalance positions.

The first sensing unit 151 is coupled to one side portion of the fixed frame 130 to sense acceleration according to the rotation of the disks 11. The second sensing unit 152 is coupled to the other side portion of the fixed frame 130 and connected to the movable frame 140 to measure a force generated by the imbalance of the disks 11. In the illustrated embodiment, an accelerometer is used as the first sensing unit 151 and a load cell is used as a second sensing unit 152. The second sensing unit 152 may be omitted. The load cell is a force-transducer that generates electric output in proportional to the amount of a load applied. The imbalance values for a plurality of disks may be detected by measuring a force generated by the imbalance value of the disk. That is, imbalance values for the disks may be measured.

The device 100 for manufacturing an HDD according to an embodiment of the inventive concept further includes a control unit 160 to control the impact application unit 110. The control unit 160 calculates an amount of impact to be applied to the HDD 1 based on the accelerations of the disks sensed by the acceleration sensing unit 150 and controls the impact application unit 110 based on the calculated impact amount. In the illustrated embodiment, the control unit 160 is implemented as a system having a PCI Extensions for Information (PXI). The PXI is a conventionally understood, open standard related to measurement, data collection, and automation which enables faster execution of a variety of applied programs by combining timing and triggering included in a system and a high speed PCI.

The control unit 160 is connected to a PC via a hub 162 as necessary. In this case, the control unit 160 receives a signal provided by the acceleration sensing unit 150 and calculates the amount of an impact based on the received signal, and transfers the calculated impact amount to the impact application unit 110. The PC is used to load or monitor a program such as an operation program. The control unit 160 may be replaced by a system having a digital signal processor (DSP) that is a microprocessor formed of a single IC performing signal processing using a digital operation, in addition to the PXI. However, the present invention is not limited by the type of implementation of a system having the control unit 160.

In the device 100 for manufacturing an HDD according to an embodiment of the inventive concept, since an impact is applied to the HDD 1 using the solenoid 111, the device 100 may be implemented at a relatively low cost. Also, as the impact application unit 110 and the movable frame 140 are separated by the fixed frame 130, particles generated by the impact applied to the HDD 1 are prevented from being absorbed into the disks 11 so that reliability of the HDD 1 that is completely manufactured may be improved.

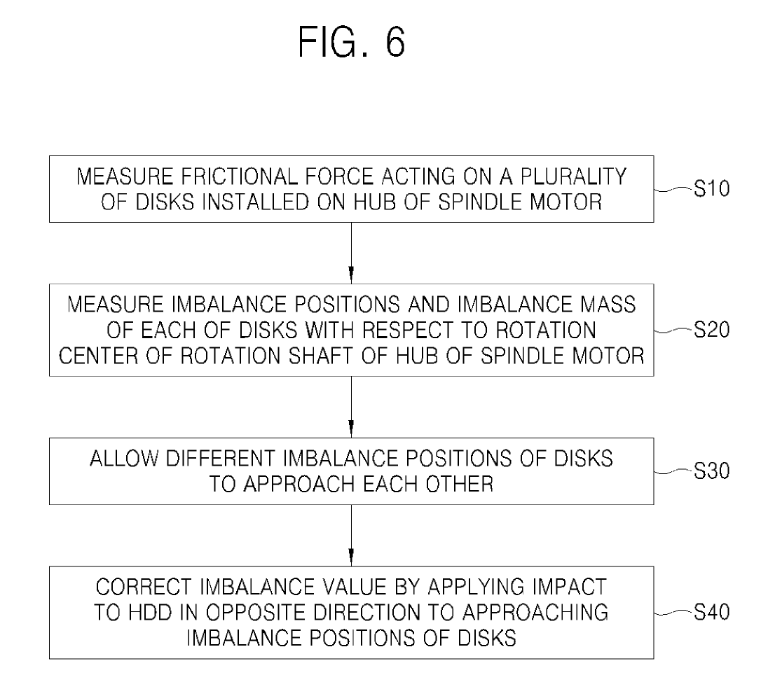

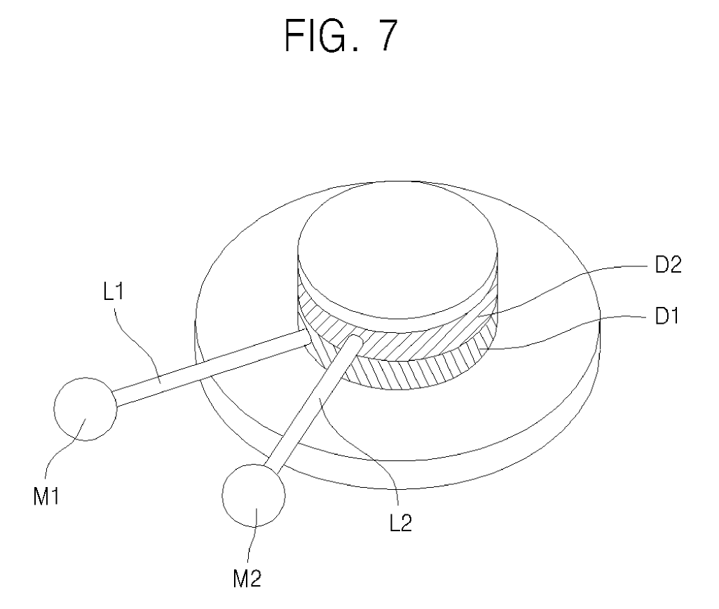

A method of manufacturing an HDD according to an embodiment of the inventive concept will now be described in some additional detail. FIG. 6 is a flowchart summarizing a method of manufacturing an HDD according to an embodiment of the inventive concept. FIG. 7 schematically illustrates imbalance values of a plurality of disks according to an embodiment of the present inventive concept.

Referring to FIGS. 6 and 7, in the HDD 1, a first disk D1 and a second disk D2 are temporarily fixed by the clamp 15 of FIG. 1 elastically pressing the disks D1 and D2. The temporarily fixed state means that the disks D1 and D2 are not completely fixed by the clamp 15. That is, in the above-described device 100 for manufacturing an HDD according to the present embodiment, after the HDD 1 having the first and second disks D1 and D2 is accommodated on the main frame 142 of the movable frame 140, as the impact application unit 110 applies an impact, the first and second disks D1 and D2 may slip in the opposite direction to a direction in which the impact is applied. A state in which the slip of the disks D1 and D2 are allowed by the impact is referred to as the temporarily fixed state.

Referring to FIG. 6, a method of manufacturing an HDD according to an embodiment of the inventive concept includes measuring a frictional force acting on a plurality of disks installed on a hub (not shown) of the spindle motor 13 (S10), measuring imbalance positions and imbalance mass of each of the disks with respect to a rotation center of a rotation shaft of the hub of the spindle motor 13 (S20), allowing the different imbalance positions of the disks to approach each other (S30), and correcting an imbalance value by applying an impact to the HDD in a direction opposite to the imbalance positions of the approaching disks (S40).

In the operation (S10) in which a frictional force acting on the disks installed on the hub of the spindle motor 13 is measured, prior to correcting the imbalance values of the first and second disk D1 and D2, a frictional force acting on each of the first and second disks D1 and D2 is measured in advance. In the HDD 1 manufactured using the device 100, the first disk D1 receives a frictional force due to the hub and the spacer and the second disk D2 receives a frictional force due to the spacer and the clamp 15 of FIG. 1. Also, when another spacer (not shown) is interposed between the hub and the first disk D1, the first disk D1 may receive a frictional force due to the spacers arranged at the upper and lower sides of the first disk D1.

Accordingly, since the frictional forces act between the first and second disks D1 and D2 and each of the elements constituting the HDD 1 such as the hub, the spacer, and the clamp 15, to correct the imbalance values of the first and second disks D1 and D2 according to the illustrated embodiment, the amount of the frictional force generated when the first and second disks D1 and D2 slip need to be accurately identified.

Considering the above, the method of manufacturing an HDD according the illustrated embodiment includes the operation (S10) prior to the operation (S40) for correcting the imbalance value. The frictional force may be measured by a general tension test. Since the frictional force of the first and second disks D1 and D2 are accurately identified by the above method, the accurate amount of an impact needed to slip the first and second disks D1 and D2 may be calculated.

In the operation (S20) in which imbalance positions and imbalance mass of each of the disks are measured with respect to a rotation center of a rotation shaft of the hub of the spindle motor 13, acceleration of each of the disks installed on the hub of the spindle motor is detected and thus the imbalance value including the imbalance position of the rotation center of the rotation shaft of the hub with respect to each of the disks is measured.

Also, the imbalance position signifies how the centers of the first and second disks D1 and D2 in the temporarily fixed state are separated from the center of the rotation shaft of the hub. As described above, the operation (S20) is performed by the acceleration sensing unit 150 provided in the device 100 for manufacturing an HDD according to an embodiment of the inventive concept.

That is, the imbalance value is measured using the acceleration sensing unit 150. Since the imbalance value measured using the acceleration sensing unit 150 is measured in the state in which the first and second disks D1 and D2 rotate, the imbalance value may be a vibrating cyclic waveform. For example, when the imbalance position of the first disk D1 approaches a position where the acceleration sensing unit 150 is installed, that is, a side portion of the fixed frame 130 in the device 100 for manufacturing an HDD according to the present embodiment, acceleration of the first disk D1 measured by the acceleration sensing unit 150 gradually increases. When the position where the acceleration sensing unit 150 is installed accurately matched the imbalance position of the first disk D1, the acceleration of the first disk D1 has the maximum value in a positive (+) direction.

Also, when the imbalance position of the first disk D1 is separated from the position where the acceleration sensing unit 150 is installed, the acceleration of the first disk D1 measured by the acceleration sensing unit 150 gradually decreases. When the position where the acceleration sensing unit 150 is installed and the imbalance position of the first disk D1 accurately make 180°, the acceleration of the first disk D1 has the maximum value in a negative (−) direction. Since the same conditions apply to the second disk D2, a detailed description thereof will be omitted herein. However, the imbalance values of the first and second disks D1 and D2 measured by the acceleration sensing unit 150 are different from each other unless the centers of the first and second disks D1 and D2 are completely matched each other. In this case, an acceleration graph of the second disk D2 may be detected to be different from that of the first disk D1 in the amplitude and phase.

FIG. 7 schematically illustrates imbalance values for a plurality of disks according to an embodiment of the inventive concept. Referring to FIG. 7, the first and second disks D1 and D2 have imbalance values as illustrated with respect to the position where the acceleration sensing unit 150 is installed. In FIG. 7, the imbalance values of the first and second disks D1 and D2, that is, imbalance positions L1 and L2 and imbalance mass M1 and M2, are exaggerated for purposes of explanation. This conceptual explanation technique does not suggest that imbalance masses M1 and M2 are actually added to the first and second disks D1 and D2.

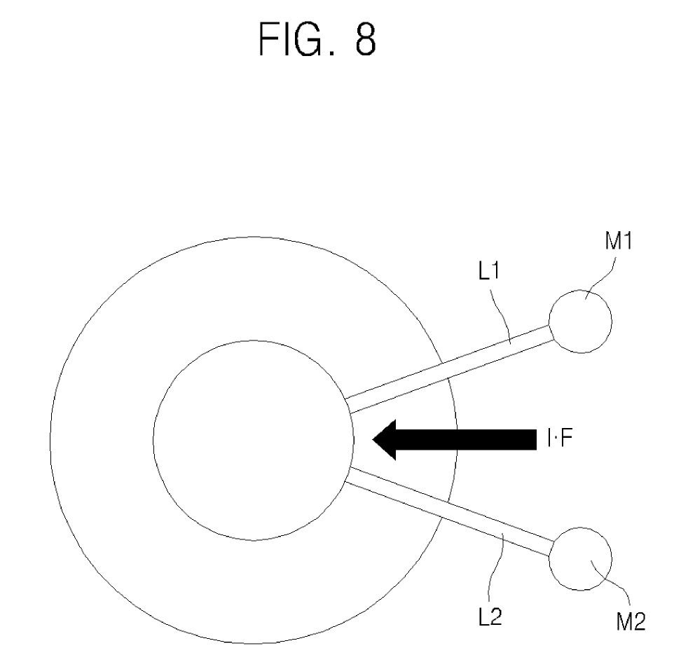

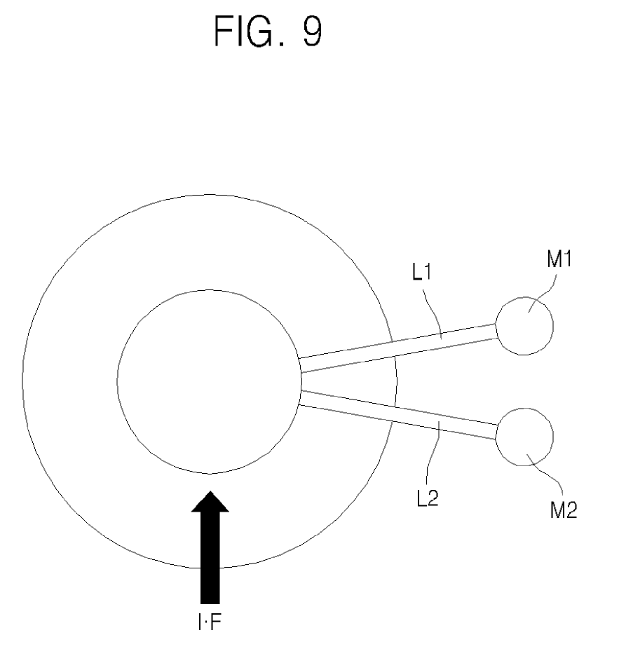

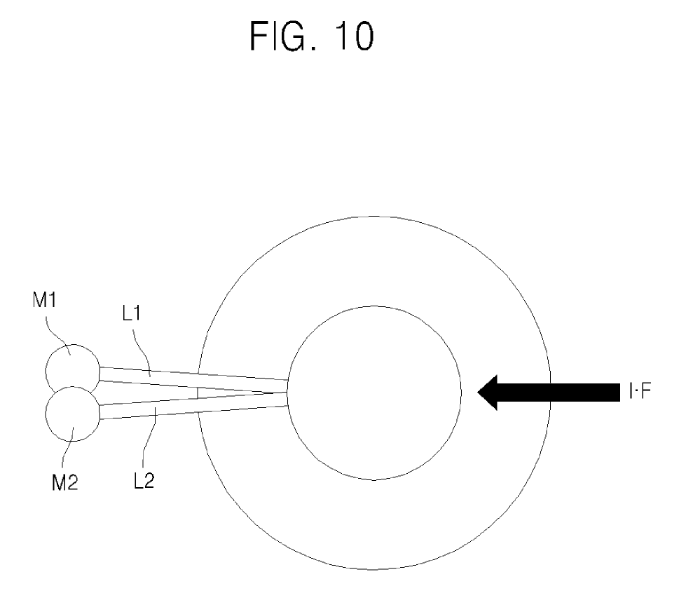

FIG. 8 schematically illustrates that different imbalance positions L1 and L2 of the first and second disks D1 and D2 of FIG. 7 are made to approach each other as an impact is applied to the HDD 1 at a direction within a defined angular range made by the imbalance positions L1 and L2. FIG. 9 schematically illustrates that different imbalance positions L1 and L2 of the first and second disks D1 and D2 of FIG. 7 are made to approach each other as an impact is applied to the HDD 1 when an angle made by the imbalance positions L1 and L2 is not greater than a predetermined angle range. FIG. 10 schematically illustrates that an imbalance value is corrected by applying an impact to the HDD 1 in a direction opposite to the imbalance positions L1 and L2 of the first and second disks D1 and D2 approaching each other as a result of the manner of FIG. 8 or 9.

Referring to FIGS. 8-10, in the operation (S30) in which the different imbalance positions of the disks approach each other, the different imbalance positions L1 and L2 of the first and second disks D1 and D2 are made to approach each other in the circumferential direction of the first and second disks D1 and D2 by applying an impact to the HDD 1. That is, the different imbalance positions are made to approach each other such that the first and second disks D1 and D2 may act similarly like a single disk.

When an impact is applied to the HDD 1 without considering the imbalance positions L1 and I2 of the first and second disks D1 and D2, the imbalance values of any one of the first and second disks D1 and D2 may be corrected. However, it seems to be difficult to consider that the imbalance value of the other disk is corrected. Thus, embodiments of the inventive concept include the operation of allowing the different imbalance positions of the first and second disks D1 and D2 to approach each other.

Referring to FIGS. 6 and 8, in the operation (S30), an impact, that is, an impact force (I·F), is applied to the HDD 1 in a direction within an angle of 180° made by the imbalance positions L1 and L2 of the first and second disks D1 and D2 with respect to the rotation shaft of the hub. When the impact force (I·F) is applied to the HDD 1 in a direction within an angle of 180° made by the imbalance positions L1 and L2 of the first and second disks D1 and D2 considering the imbalance positions L1 and L2 of the first and second disks D1 and D2 together, the first and second disks D1 and D2 in the temporarily fixed state slip with respect to the rotation shaft of the hub. Accordingly, the imbalance positions L1 and L2 of the first and second disks D1 and D2 approach each other with respect to the direction in which the impact force (I·F) is applied. The amount of an impact required to allow the imbalance positions L1 and L2 of the first and second disks D1 and D2 to approach each other is determined in relation to a frictional force generated during the slipping of the first and second disks D1 and D2 and a detailed description thereof will be discussed later.

Referring to FIGS. 6 and 9, in the operation S30, an impact force (I·F) is applied to the HDD 1 in a direction crossing an imagery line connecting the rotation shaft of the hub and the imbalance positions L1 and L2 of the first and second disks D1 and D2 when the angle made by the imbalance positions L1 and L2 of the first and second disks D1 and D2 is smaller than a predetermined angle range with respect to the rotation shaft of the hub.

Unlike the method of applying the impact force (I·F) to the HDD 1 in a direction within an angle of 180° made by the imbalance positions L1 and L2 of the first and second disks D1 and D2 (see FIG. 8), the method of FIG. 9 is used when the angle made by the imbalance positions L1 and L2 of the first and second disks D1 and D2 is smaller than a predetermined reference which is determined according to the allowance range of the imbalance of the HDD 1. That is, when the angle made by the imbalance positions L1 and L2 of the first and second disks D1 and D2 is not greater than a reference value, it may be more efficient to allow the imbalance positions L1 and L2 of the first and second disks D1 and D2 to approach each other according to the method of FIG. 9, than the method of FIG. 8 in which the impact force (I·F) is applied to a central portion if the HDD 1 in a direction within the angle made by the imbalance positions L1 and L2 of the first and second disks D1 and D2. The amount of an impact to be applied is determined based on the frictional forces of the first and second disks D1 and D2.

Referring to FIGS. 6 and 10, in the operation S40 in which an imbalance value is corrected by applying an impact to the HDD in a direction opposite to the imbalance positions of the approaching disks, the imbalance values of the first and second disks D1 and D2 approaching each other are corrected together according to the method of FIG. 8 or 9. That is, in the operation (S30), the impact force (I·F) is applied to the HDD 1 in a direction opposite to the imbalance positions L1 and L2 of the first and second disks D1 and D2 with respect to the rotation shaft of the hub so that the imbalance positions L1 and L2 of the first and second disks D1 and D2 approaching each other may be moved in the radial direction of the first and second disks D1 and D2 to the rotation center of the rotation shaft of the hub.

As described above, when the imbalance positions L1 and L2 of the first and second disks D1 and D2 are made to approach each other according to the method of FIG. 8 or 9, the first and second disks D1 and D2 may be considered like a single disk D1 or D2. Accordingly, the imbalance values of the first and second disks D1 and D2 may be corrected together. The amount of an impact applied to the HDD 1 is determined based on the frictional forces of the first and second disks D1 and D2.

In the HDD 1 in which the dynamic imbalance value is corrected according to the present embodiment, slip marks generated by the slipping of the first and second disks D1 and D2 are left on the surface of the disk. A slip mark forming angle made between a slip mark of the first disk D1 and a slip mark of the second disk D2 is within a range of 180°. Also, since the slip marks generated by the slipping of the first and second disks D1 and D2 has merely a small amount, the slip mark does not affect the read/write function of the first and second disks D1 and D2.

Thus, according to the method of manufacturing an HDD according to an embodiment of the inventive concept, after the different imbalance positions of at least two disks are made to approach each other, an impact is applied in the opposite direction to the approaching two imbalance positions so that the at least two imbalance values may be simply corrected. The method of manufacturing the HDD 1 according the present embodiment will be described in detail in relation to the above-described HDD manufacturing device 100.

Referring to FIG. 5, the disks 11, for example, the first and second disks D1 and D2, constituting the HDD 1, are coupled to the HDD 1 in the temporarily fixed state. The movement of the HDD 1 is limited by the bracket 144 provided at each corner of the movable frame 140. The dynamic imbalance value generated by the rotation of the disks 11 is sensed by the acceleration sensing unit 150 and transferred to the control unit 160. The control unit 160 determines the imbalance positions of the disks 11 based on the dynamic imbalance value of each disk and calculates the amount of an impact to correct the imbalance values of the disks 11 based on the predetermined frictional force of each disk.

The control unit 160 determines the timing to generate an impact considering the imbalance position of the disks 11. The information about the timing and the calculated amount of an impact are transferred to the impact application unit 110 via the control unit 160. The impact application unit 110 generates an impact to the HDD 1 having the disks 11 that are rotating, according to the control of the control unit 160. The movable iron core 111a is moved horizontally, that is, in the direction X or −X.

As the movable iron core 111a is moved, the connection member 120 coupled to the movable iron core 111a is moved in the same direction as the direction in which the movable iron core 111a is moved. Accordingly, the movable frame 140 coupled to the connection member 120 is relatively moved along the guide rail 131 provided on the upper surface of the fixed frame 130. The first and second disks D1 and D2 receive a force in the opposite direction to the movement of the movable frame 140 by inertia. Thus, the slipping of the first and second disks D1 and D2 is generated so that the imbalance value of the disks 11 may be corrected.

As described above, according to the present inventive concept, the imbalance of an HDD may be simply and accurately corrected. In particular, the imbalance may be more effectively corrected in an HDD having a plurality of disks, compared to a related art.

While the inventive concept has been particularly shown and described with reference to exemplary embodiments thereof, it will be understood that various changes in form and details may be made therein without departing from the scope of the following claims.

What is claimed is:

1. A method of manufacturing a hard disk drive, comprising:
for each one of a plurality of disks installed on a hub of a spindle motor rotating the plurality of disks, measuring an imbalance value including an imbalance position with respect to a rotation center of a rotation shaft of the hub;
allowing different imbalance positions for disks in the plurality of disks to approach each other in a circumferential direction by applying an impact to the hard disk drive; and
correcting at least one imbalance value by applying an impact to the hard disk drive in a direction opposite to a corresponding imbalance position for a disk in the plurality of disks, wherein different imbalance values are made to approach each other with respect to the rotation shaft of the hub, and different imbalance positions of disks in the plurality of disks are made to approach each other in a radial direction with respect to the rotation center of the rotation shaft of the hub.

2. The method of claim 1, wherein allowing different imbalance positions for the disks in the plurality of disks to approach each other results in the imbalance positions of the disks being made to approach each other by applying an impact to the hard disk drive in a direction within an angular range of 180° made by the imbalance positions of the disks with respect to the rotation shaft of the hub.

3. The method of claim 1, wherein allowing of different imbalance positions for the disks in the plurality of disks to approach each other comprises:
applying an impact to the hard disk drive in a direction crossing an imagery line connecting the rotation shaft of the hub and the imbalance positions of the disks, thereby allowing the imbalance positions of the disks to approach each other when an angle made by the imbalance positions of the disks is less than a predetermined angular range with respect to the rotation shaft of the hub.

4. The method of claim 1, wherein measuring an imbalance value including an imbalance position with respect to a rotation center of a rotation shaft of the hub results in an imbalance value for each one of the plurality of disks being measured by detecting acceleration for each one of the plurality of disks.

5. The method of claim 1, further comprising:
measuring a frictional force acting on each of the disks installed on the hub.

6. A hard disk drive comprising:
a hub of a spindle motor; and
a plurality of disks installed on the hub, wherein a slip mark is formed on a surface of each one of the plurality of disks within an angular range of 180° in a circumferential direction with respect to the center of each of the disks.

7. The hard disk drive of claim 6, wherein the slip mark is formed when an impact is applied to the hard disk drive to allow different imbalance positions associated with each one of the plurality of disks to approach each other in the circumferential direction with respect to a rotation center of a rotation shaft of the hub.

8. A device for manufacturing a hard disk drive comprising:
a movable frame supporting the hard disk drive having a plurality of disks; and
an impact application unit connected to the movable frame and configured to apply an impact to the hard disk drive during rotation of the disks.

9. The device of claim 8, further comprising:
a fixed frame arranged under the movable frame, wherein the movable frame is coupled to the fixed frame in a manner allowing relative movement of the moveable frame with respect to fixed frame,
wherein the impact application unit is arranged under the fixed frame and is connected to the fixed frame via a through hole formed in the fixed frame.

10. The device of claim 9, wherein the impact application unit comprises:
a solenoid arranged under the fixed frame to be separated from the movable frame and generating an impact force to apply an impact to the movable frame; and
a connection member arranged to penetrate the through hole and connecting the solenoid and the movable frame.

11. The device of claim 10, wherein the fixed frame further comprises a guide rail guiding a movement of the movable frame, and the movable frame comprises:
a connection member coupling plate coupled to an end portion of the connection member;
a main frame detachably coupled to the connection member coupling plate; and
a guide rail coupling portion arranged at a lower end portion of the main frame and coupled to the guide rail to be capable of relatively moving.

12. The device of claim 9, further comprising:
an acceleration sensing unit provided at a side of the fixed frame and sensing acceleration of each one of the plurality of disks.

13. The device of claim 12, further comprising:
a control unit calculating an amount of an impact to be applied to the hard disk drive based on acceleration of each one of the plurality of disks sensed by the acceleration sensing unit and controlling the impact application unit based on the calculated amount of an impact.
